(19) United States
(12) Patent Application Publication
(10) Pub. No.: US 2025/0391370 A1
(43) Pub. Date: Dec. 25, 2025

(54) SUB-PIXEL AND DISPLAY DEVICE INCLUDING THE SAME, AND ELECTRONIC DEVICE

(71) Applicant: Samsung Display Co., Ltd., Yongin-si (KR)

(72) Inventors: Jin Joo HA, Yongin-si (KR); Kyung Bae KIM, Yongin-si (KR); Dong Woo KIM, Yongin-si (KR)

(21) Appl. No.: 19/184,575

(22) Filed: Apr. 21, 2025

(30) Foreign Application Priority Data
Jun. 19, 2024 (KR) 10-2024-0079900
Jul. 16, 2024 (KR) 10-2024-0093684

(51) Int. Cl. G09G 3/3241

(52) U.S. Cl. CPC G09G 3/3241; G09G 2300/0819; G09G 2300/0852; G09G 2300/0861; G09G 2310/08

(57) ABSTRACT

A sub-pixel includes: a first transistor having a first electrode connected via a first node to a first power supply voltage node configured to receive a first power supply voltage, a second electrode connected to a second node, and a gate electrode connected to a third node; a light emitting element connected between the second node and a second power supply voltage node configured to receive a second power supply voltage; a second transistor connected between a data line and the third node, and having a gate electrode which is connected to a first sub-gate line; a first capacitor connected between the first node and the third node; a second capacitor connected between an initialization voltage node configured to receive an initialization voltage and the third node; and a third capacitor connected between the third node and the second node.

### CROSS-REFERENCE TO RELATED APPLICATION

The present application claims priority to and the benefit of Korean Patent Application No. 10-2024-0079900, filed on Jun. 19, 2024, and Korean Patent Application No. 10-2024-0093684, filed on Jul. 16, 2024, in the Korean Intellectual Property Office, the entire disclosures of each of which are incorporated herein by reference.

### BACKGROUND

### 1. Field

Aspects of some embodiments of the present disclosure relate to a sub-pixel and a display device including the same, and electronic device.

### 2. Description of the Related Art

With development of information technology, the importance of display devices, which provide a connection medium between users and information, is highlighted. Accordingly, the use of display devices such as liquid crystal display devices and organic light emitting display devices is increasing.

Recently, a sub-pixel applicable to a high-resolution panel is in demand.

The above information disclosed in this Background section is only for enhancement of understanding of the background and therefore the information discussed in this Background section does not necessarily constitute prior art.

### SUMMARY

Aspects of some embodiments of the present disclosure include a sub-pixel applicable to a high-resolution panel and a display device including the same.

A sub-pixel according to some embodiments of the present disclosure includes: a first transistor having a first electrode which is connected via a first node to a first power supply voltage node to which a first power supply voltage is inputted, a second electrode which is connected to a second node, and a gate electrode which is connected to a third node; a light emitting element connected between the second node and a second power supply voltage node to which a second power supply voltage is inputted; a second transistor connected between a data line and the third node, and having a gate electrode which is connected to a first sub-gate line; a first capacitor connected between the first node and the third node; a second capacitor connected between an initialization voltage node to which an initialization voltage is inputted and the third node; and a third capacitor connected between the third node and the second node.

According to some embodiments, the sub-pixel further includes a third transistor connected between the first power supply voltage node and the first node, and having a gate electrode which is connected to an emission control line.

According to some embodiments, the sub-pixel further includes a fourth transistor connected between the second node and the initialization voltage node, and having a gate electrode which is connected to a second sub-gate line.

According to some embodiments, the first transistor, the second transistor and the third transistor are P-type transistors, and the fourth transistor is an N-type transistor.

According to some embodiments, each of the first to fourth transistors includes a body electrode, and the first power supply voltage is supplied to the body electrode of each of the first to third transistors, and the initialization voltage is supplied to the body electrode of the fourth transistor.

According to some embodiments, one horizontal period is divided into a first period, s second period and a third period, the second transistor is turned on during the first period and the second period, the fourth transistor is turned on during the first period to the third periods, and the third transistor is turned off during the second period.

According to some embodiments, a voltage of a data signal is supplied to the data line during the first period to the third period.

According to some embodiments, the third transistor is further turned off during the first period.

According to some embodiments, the initialization voltage is a voltage by which the light emitting element is turned off when the voltage is supplied to the light emitting element.

According to some embodiments, the sub-pixel further includes a fourth transistor connected between the second node and an auxiliary initialization voltage node to which an auxiliary initialization voltage is supplied, and having a gate electrode which is connected to a second sub-gate line, wherein the auxiliary initialization voltage is a voltage which is different from the initialization voltage.

A display device according to some embodiments of the present disclosure includes: sub-pixels connected to data lines, gate lines and emission control lines; a gate driver for driving the gate lines and the emission control lines; and a data driver for driving the data lines, each of the sub-pixels including: a first transistor having a first electrode which is connected via a first node to a first power supply voltage node to which a first power supply voltage is inputted, a second electrode which is connected to a second node, and a gate electrode which is connected to a third node; a light emitting element connected between the second node and a second power supply voltage node to which a second power supply voltage is inputted; a second transistor connected between a data line which is any one of the data lines and the third node, and having a gate electrode which is connected to a first sub-gate line which is any one of the gate lines; a first capacitor connected between the first node and the third node; a second capacitor connected between an initialization voltage node to which an initialization voltage is inputted and the third node; and a third capacitor connected between the third node and the second node.

According to some embodiments, each of the sub-pixels further includes a third transistor connected between the first power supply voltage node and the first node and having a gate electrode which is connected to an emission control line which is any one of the emission control lines.

According to some embodiments, each of the sub-pixels further includes a fourth transistor connected between the second node and the initialization voltage node and having a gate electrode which is connected to a second sub-gate line which is any one of the gate lines.

According to some embodiments, the first transistor, the second transistor and the third transistor are P-type transistors, and the fourth transistor is an N-type transistor.

According to some embodiments, each of the first to fourth transistors includes a body electrode, and the first power supply voltage is supplied to the body electrode of each of the first to third transistors, and the initialization voltage is supplied to the body electrode of the fourth transistor.

According to some embodiments, one horizontal period is divided into a first period, s second period and a third period, and the gate driver supplies a first scan signal with a gate-on voltage to the first sub-gate line during the first period and the second period, supplies a second scan signal with a gate-on voltage to the second sub-gate line during the first period to the third period, and supplies an emission control signal with a gate-off voltage to the emission control line during the second period.

According to some embodiments, the data driver supplies a voltage of a data signal to the data line during the first period to the third period.

According to some embodiments, the gate driver further supplies the emission control signal to the emission control line during the first period.

According to some embodiments, each of the sub-pixels further includes a fourth transistor connected between the second node and an auxiliary initialization voltage node to which an auxiliary initialization voltage is supplied and having a gate electrode which is connected to a second sub-gate line which is any one of the gate lines, and the auxiliary initialization voltage is a voltage which is different from the initialization voltage.

An electronic device according to some embodiments of the present disclosure includes: a processor to provide image data; a display device to display an image based on the image data. The display device includes: sub-pixels connected to data lines, gate lines and emission control lines; a gate driver for driving the gate lines and the emission control lines; and a data driver for driving the data lines, each of the sub-pixels including: a first transistor having a first electrode which is connected via a first node to a first power supply voltage node to which a first power supply voltage is inputted, a second electrode which is connected to a second node, and a gate electrode which is connected to a third node; a light emitting element connected between the second node and a second power supply voltage node to which a second power supply voltage is inputted; a second transistor connected between a data line which is any one of the data lines and the third node, and having a gate electrode which is connected to a first sub-gate line which is any one of the gate lines; a first capacitor connected between the first node and the third node; a second capacitor connected between an initialization voltage node to which an initialization voltage is inputted and the third node; and a third capacitor connected between the third node and the second node.

It should be noted that aspects of embodiments according to the present disclosure are not limited to those described above and other technical characteristics of embodiments according to the present disclosure will be more apparent to those skilled in the art from the following descriptions.

By the sub-pixel and the display device including the same according to some embodiments of the present disclosure, the voltage range (data swing range) of a data signal may be sufficiently secured, and accordingly, a grayscale may be relatively stably implemented. In addition, in the embodiments of the present disclosure, a sub-pixel may be configured using four transistors and three capacitors, and thus, may be applied to a high-resolution panel.

The characteristics of embodiments according to the present disclosure are not limited to the characteristics described above, and may be expanded in various ways without departing from the spirit and scope of embodiments according to the present disclosure.

### BRIEF DESCRIPTION OF THE DRAWINGS

FIG. 1 is a block diagram showing aspects of a display device according to some embodiments of the present disclosure.

FIG. 2 is a block diagram showing aspects of a sub-pixel of FIG. 1 according to some embodiments of the present disclosure.

FIG. 3 is a diagram showing aspects of a gate driver for driving the sub-pixel shown in FIG. 2 according to some embodiments of the present disclosure.

FIG. 4 is a circuit diagram showing aspects of a sub-pixel of FIG. 2 according to some embodiments of the present disclosure.

FIG. 5 is a circuit diagram showing aspects of a sub-pixel of FIG. 2 according to some embodiments of the present disclosure.

FIG. 6 is a waveform diagram showing aspects of a method for driving the sub-pixel shown in FIGS. 4 and 5 according to some embodiments of the present disclosure.

FIGS. 7A to 7D are diagrams showing aspects of an operation process of a sub-pixel corresponding to driving waveforms of FIG. 6 according to some embodiments of the present disclosure.

FIG. 8 is a waveform diagram showing aspects of a method for driving the sub-pixel shown in FIGS. 4 and 5 according to some embodiments of the present disclosure.

FIG. 9 is a plan view showing aspects of a display panel of FIG. 1 according to some embodiments of the present disclosure.

FIG. 10 is a plan view showing aspects of a pixels of FIG. 9 according to some embodiments of the present disclosure.

FIG. 11 is a plan view showing aspects of a pixel of FIG. 9 according to some embodiments of the present disclosure.

FIG. 12 is a block diagram showing aspects of a display system according to some embodiments of the present disclosure.

FIG. 13 is a perspective view showing an application example of the display system of FIG. 12 according to some embodiments of the present disclosure.

FIG. 14 is a diagram showing a head-mounted display worn by a user according to some embodiments of the present disclosure.

### DETAILED DESCRIPTION

Hereinafter, aspects of some embodiments of the present disclosure will be described in more detail with reference to the accompanying drawings. The following descriptions will be focused on only portions required for understanding operations in accordance with the present disclosure, and the descriptions of the other portions may be omitted in order not to unnecessarily obscure the subject matter of embodiments according to the present disclosure. The present disclosure should not be construed as being limited to the embodiments set forth herein and may be embodied in different forms. The embodiments to be described below are provided to describe aspects of some embodiments of the present disclosure in more detail to the extent that a person skilled in the art to which the present disclosure pertains can easily carry out the technical ideas of the present disclosure.

Throughout the specification, when one element is referred to as being ‘connected to’ or ‘coupled to’ another element, it may indicate that the former element is directly connected or coupled to the latter element or indirectly connected or coupled to the latter element with another element interposed therebetween. The terminology used herein is for the purpose of describing particular embodiments and is not intended to limit the present disclosure. Throughout the specification, when an element “includes” a component, it may indicate that the element does not exclude another component unless referred to the contrary, but can further include another component. “At least any one of X, Y and Z” and “at least any one selected from a group consisting of X, Y and Z” may be construed as each of X, Y and Z or a combination of two or more of X, Y and Z (for example, XYZ, XYY, YZ and ZZ). As used herein, the term “and/or” includes any and all combinations of one or more of associated listed items. As used herein, the term “and/or” includes any and all combinations of one or more of associated listed items.

Although the terms “first,” “second,” etc. may be used herein to describe various components, these components are not limited by these terms. These terms are used to distinguish one component from another component. Thus, a first component could be termed a second component without departing from the teachings of the present disclosure.

Spatially relative terms, such as “under,” “on” and the like, may be used herein for descriptive purposes, and, thereby, to describe one element or feature's relationship to another element(s) or feature(s) as illustrated in the drawings. Spatially relative terms are intended to encompass different directions in use, operation, and/or manufacture in addition to the direction depicted in the drawings. For example, if a device depicted in drawings is turned over, elements described as being located “under” other elements or features would then be located “on” the other elements or features. Thus, the term “under” can encompass both directions of on and under. Furthermore, the device may be otherwise oriented (e.g., rotated 90 degrees or in other directions), and, as such, the spatially relative terms used herein are interpreted accordingly.

Various embodiments will be described herein with reference to drawings that are schematic illustrations of idealized embodiments. Accordingly, variations in the shapes of the illustrations as a result, for example, of tolerances and/or manufacturing techniques are to be expected. Thus, the embodiments disclosed herein should not be construed as being limited to the particular illustrated shapes, but should be construed as including changes in shapes that result from, for instance, manufacturing. In this manner, shapes illustrated in the drawings may not illustrate the actual shapes of regions of the device, and the embodiments are not limited thereto.

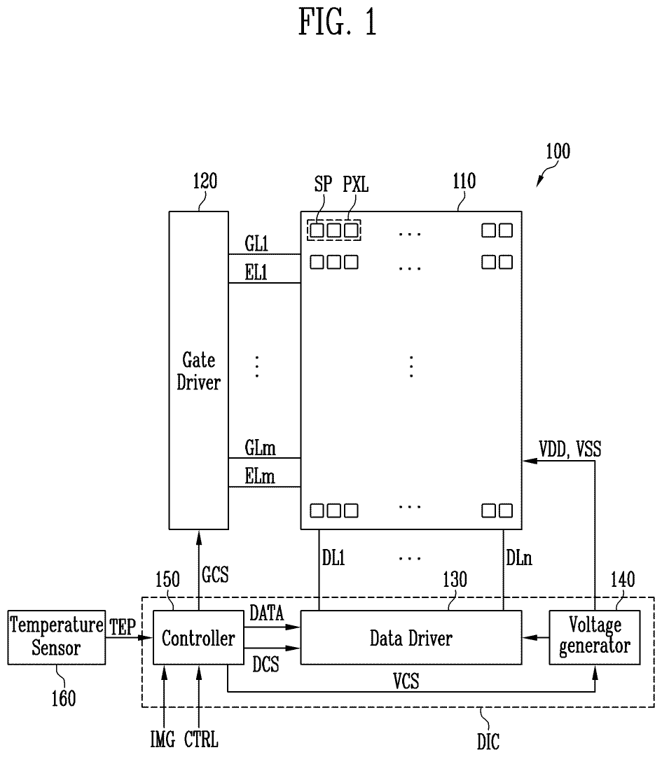

FIG. 1 is a block diagram showing aspects of a display device according to some embodiments of the present disclosure.

Referring to FIG. 1, a display device 100 may include a display panel 110, a gate driver 120, a data driver 130, a voltage generator 140, and a controller 150.

The display panel 110 includes sub-pixels SP. The sub-pixels SP may be connected to the gate driver 120 through first to mth gate lines GL1 to GLm. The sub-pixels SP may be connected to the data driver 130 through first to nth data lines DL1 to DLn.

Each of the sub-pixels SP may include at least one light emitting element which is configured to generate light. Accordingly, each of the sub-pixels SP may generate light of a specific color such as red, green, blue, cyan, magenta or yellow. Two or more sub-pixels SP among the sub-pixels SP may constitute one pixel PXL. For example, as shown in FIG. 1, three sub-pixels SP may constitute one pixel PXL. Collectively, the pixels PXL, including their sub-pixels SP, may be utilized to display images by emitting light based on data signals and gate or scan signals.

The gate driver 120 is connected to sub-pixels SP which are arranged in a row direction, through the first to mth gate lines GL1 to GLm. The gate driver 120 may output scan signals to the first to mth gate lines GL1 to GLm in response to a gate control signal GCS. According to some embodiments, the gate control signal GCS may include a start signal which indicates the start of each frame, a horizontal synchronization signal for outputting scan signals in synchronization with timing at which data signals are applied, etc.

According to some embodiments, first to mth emission control lines EL1 to ELm which are connected to sub-pixels SP in the row direction may be further provided. In this case, the gate driver 120 may include an emission driver which is configured to control the first to mth emission control lines EL1 to ELm, and the emission driver may operate under the control of the controller 150.

The gate driver 120 may be located on one side of the display panel 110. However, embodiments are not limited thereto. For example, the gate driver 120 may be divided into two or more drivers which are physically and/or logically separated, and such drivers may be located on one side of the display panel 110 and the other side of the display panel 110 opposite to the one side. In this way, the gate driver 120 may be arranged around the display panel 110 (e.g., in a periphery or outside a footprint of a display area of the display panel 110) in various forms according to embodiments.

The data driver 130 is connected to sub-pixels SP which are arranged in a column direction, through the first to nth data lines DL1 to DLn. The data driver 130 receives image data DATA and a data control signal DCS from the controller 150. The data driver 130 operates in response to the data control signal DCS. According to some embodiments, the data control signal DCS may include a source start pulse, a source shift clock, a source output enable signal, etc.

The data driver 130 may apply data signals with grayscale voltages corresponding to the image data DATA to the first to nth data lines DL1 to DLn, by using voltages from the voltage generator 140. When a scan signal is applied to each of the first to mth gate lines GL1 to GLm, data signals corresponding to the image data DATA may be applied to the data lines DL1 to DLn. Accordingly, corresponding sub-pixels SP may generate light corresponding to the data signals. According to this fact, an image is displayed on the display panel 110.

According to some embodiments, the gate driver 120 and the data driver 130 may include CMOS (complementary metal-oxide semiconductor) circuit elements.

The voltage generator 140 may operate in response to a voltage control signal VCS from the controller 150. The voltage generator 140 is configured to generate a plurality of voltages and provide the generated voltages to components of the display device 100. For example, the voltage generator 140 may be configured to generate the plurality of voltages by receiving an input voltage from outside the display device 100, adjusting the received voltage and regulating the adjusted voltage.

The voltage generator 140 may generate a first power supply voltage VDD and a second power supply voltage VSS, and the generated first and second power supply voltages VDD and VSS may be provided to the sub-pixels SP. The first power supply voltage VDD may have a relatively high voltage level, and the second power supply voltage VSS may have a lower voltage level than the first power supply voltage VDD. In other embodiments, the first power supply voltage VDD or the second power supply voltage VSS may be provided by an external device of the display device 100.

Besides, the voltage generator 140 may generate various voltages. For example, the voltage generator 140 may generate an initialization voltage which is applied to the sub-pixels SP. For example, in a sensing operation for sensing electrical characteristics of transistors and/or light emitting elements of the sub-pixels SP, a reference voltage (e.g., a set or predetermined reference voltage) may be applied to the first to nth data lines DL1 to DLn, and the voltage generator 140 may generate such a reference voltage.

The controller 150 controls overall operations of the display device 100. The controller 150 receives input image data IMG from the outside and a control signal CTRL for controlling the display thereof. In response to the control signal CTRL, the controller 150 may provide the gate control signal GCS, the data control signal DCS and the voltage control signal VCS.

The controller 150 may convert the input image data IMG to be suitable for the display device 100 or the display panel 110, and may output the image data DATA. According to some embodiments, the controller 150 may align the input image data IMG to be suitable for sub-pixels SP of row units, and thereby, may output the image data DATA.

Two or more components of the data driver 130, the voltage generator 140 and the controller 150 may be mounted in an one integrated circuit. As shown in FIG. 1, the data driver 130, the voltage generator 140 and the controller 150 may be included in a driver integrated circuit DIC. In this case, the data driver 130, the voltage generator 140 and the controller 150 may be components which are functionally separated in one driver integrated circuit DIC. In other embodiments, at least one of the data driver 130, the voltage generator 140, or the controller 150 may be provided as a component which is separated from the driver integrated circuit DIC.

The display device 100 may include at least one temperature sensor 160. The temperature sensor 160 is configured to sense a temperature therearound and generate temperature data TEP which indicates the sensed temperature. According to some embodiments, the temperature sensor 160 may be arranged to be adjacent to the display panel 110 and/or the driver integrated circuit DIC.

The controller 150 may control various operations of the display device 100 in response to the temperature data TEP. According to some embodiments, the controller 150 may adjust the luminance of an image to be outputted from the display panel 110, in response to the temperature data TEP. For example, the controller 150 may adjust the data signals and first and second power supply voltages VDD and VSS by controlling components such as the data driver 130 and/or the voltage generator 140.

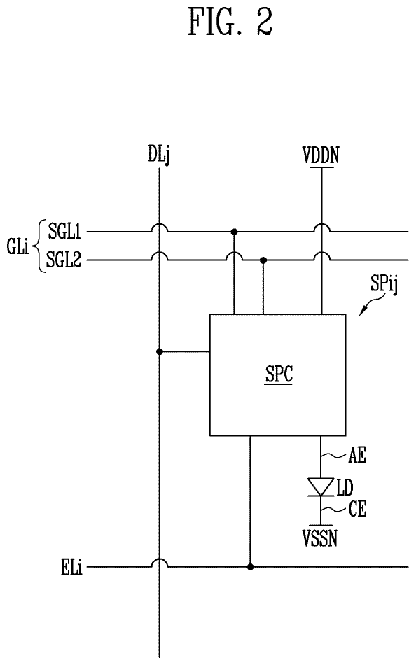

FIG. 2 is a block diagram showing aspects of any one of sub-pixels of FIG. 1 according to some embodiments. In FIG. 2, a sub-pixel SPij which is arranged in an ith (i is an integer equal to or greater than 1 and equal to or smaller than m) row and a jth (j is an integer equal to or greater than 1 and equal to or smaller than n) column among the sub-pixels SP of FIG. 1 is shown as an example.

Referring to FIG. 2, the sub-pixel SPij may include a sub-pixel circuit SPC and a light emitting element LD.

The light emitting element LD is connected between a first power supply voltage node VDDN and a second power supply voltage node VSSN. The first power supply voltage node VDDN is a node which transfers the first power supply voltage VDD of FIG. 1, and the second power supply voltage node VSSN is a node which transfers the second power supply voltage VSS of FIG. 1.

An anode electrode AE of the light emitting element LD may be connected to the first power supply voltage node VDDN through the sub-pixel circuit SPC, and the cathode electrode CE of the light emitting element LD may be connected to the second power supply voltage node VSSN. For example, the anode electrode AE of the light emitting element LD may be connected to the first power supply voltage node VDDN through one or more transistors which are included in the sub-pixel circuit SPC.

The sub-pixel circuit SPC may be connected to an ith gate line GLi among the first to mth gate lines GL1 to GLm of FIG. 1, an ith emission control line ELi among the first to mth emission control lines EL1 to ELm of FIG. 1, and a jth data line DLj among the first to nth data lines DL1 to DLn of FIG. 1. The sub-pixel circuit SPC is configured to control the light emitting element LD according to signals which are received through these signal lines.

The sub-pixel circuit SPC may operate in response to a scan signal which is received through the ith gate line GLi. The ith gate line GLi may include one or more sub-gate lines. According to some embodiments, as shown in FIG. 2, the ith gate line GLi may include first and second sub-gate lines SGL1 and SGL2. The sub-pixel circuit SPC may operate in response to scan signals which are received through the first and second sub-gate lines SGL1 and SGL2. In this way, when the ith gate line GLi includes two or more sub-gate lines, the sub-pixel circuit SPC may operate in response to scan signals which are received through the corresponding sub-gate lines.

The sub-pixel circuit SPC may operate in response to an emission control signal which is received through the ith emission control line ELi. According to some embodiments, the ith emission control line ELi may include one or more sub-emission control lines. When the ith emission control line ELi includes two or more sub-emission control lines, the sub-pixel circuit SPC may operate in response to emission control signals which are received through the corresponding sub-emission control lines.

The sub-pixel circuit SPC may receive a data signal through the jth data line DLj. The sub-pixel circuit SPC may store a voltage corresponding to the data signal in response to at least one of the scan signals which are received through the first or second sub-gate lines SGL1 or SGL2. In response to the emission control signal which is received through the ith emission control line ELi, the sub-pixel circuit SPC may adjust, according to the stored voltage, current which flows from the first power supply voltage node VDDN through the light emitting element LD to the second power supply voltage node VSSN. Accordingly, the light emitting element LD may generate light with a luminance corresponding to the data signal.

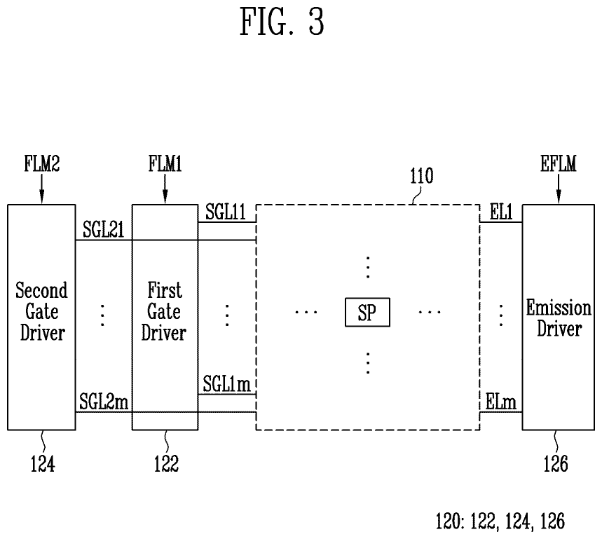

FIG. 3 is a diagram showing aspects of a gate driver for driving the sub-pixel shown in FIG. 2 according to some embodiments. The gate control signal GCS may include a first scan start signal FLM1, a second scan start signal FLM2 and an emission start signal EFLM. In addition, the gate control signal GCS may include clock signals.

Referring to FIG. 3, the gate driver 120 may include a first gate driver 122, a second gate driver 124 and an emission driver 126.

The first gate driver 122 may receive the first scan start signal FLM1, and may generate a first scan signal while shifting the first scan start signal FLM1 in response to a clock signal. The first gate driver 122 may sequentially supply the first scan signal to first sub-gate lines SGL11 to SGL1m.

The second gate driver 124 may receive the second scan start signal FLM2, and may generate a second scan signal while shifting the second scan start signal FLM2 in response to a clock signal. The second gate driver 124 may sequentially supply the second scan signal to second sub-gate lines SGL21 to SGL2m.

The first scan signal (or an enable first scan signal) and the second scan signal (or an enable second scan signal) may be set as gate-on voltages so that transistors included in sub-pixels SP may be turned on.

For example, a scan signal of a logic low level may be supplied to a P-type transistor, and a scan signal of a logic high level may be supplied to an N-type transistor. According to some embodiments, the first scan signal may be a logic low level, and the second scan signal may be a logic high level. A transistor which is supplied with the first scan signal or the second scan signal may be turned on in response to the first scan signal or the second scan signal. Thereafter, the fact that the first scan signal and the second scan signal are supplied may mean that gate-on voltages are supplied to the sub-gate lines SGL11 to SGL1m and SGL21 to SGL2m.

The first sub-gate line SGL1 shown in FIG. 2 may be any one of the first sub-gate lines SGL11 to SGL1m. The second sub-gate line SGL2 shown in FIG. 2 may be any one of the second sub-gate lines SGL21 to SGL2m.

The emission driver 126 may generate an emission control signal while shifting the emission start signal EFLM in response to a clock signal. The emission driver 126 may sequentially supply the emission control signal to the emission control lines EL1 to ELm. The emission control signal (or a disable emission control signal) may be set as a gate-off voltage so that transistors included in sub-pixels SP may be turned off.

For example, an emission control signal of a logic high level may be supplied to a P-type transistor, and an emission control signal of a logic low level may be supplied to an N-type transistor. According to some embodiments, the emission control signal may be a logic high level. A transistor which receives the emission control signal may be turned off in response to the emission control signal. Thereafter, the fact that the emission control signal is supplied may mean that a gate-off voltage is supplied to the emission control lines EL1 to ELm.

During a period in which the disable emission control signal is not supplied to the emission control lines EL1 to ELm, the emission driver 126 may supply an enable emission control signal. The enable emission control signal may be set as a gate-on voltage so that transistors included in sub-pixels SP may be turned on.

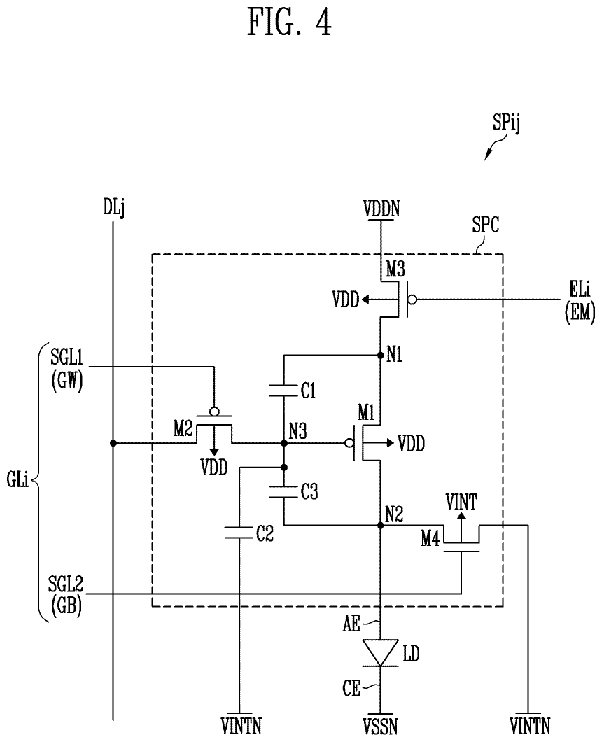

FIG. 4 is a circuit diagram showing aspects of the sub-pixel of FIG. 2 according to some embodiments. Although FIG. 4 illustrates various components in a sub-pixel according to some embodiments, embodiments according to the present disclosure are not limited thereto, and according to various embodiments, the sub-pixel may include additional components or fewer components without departing from the spirit and scope of embodiments according to the present disclosure.

Referring to FIG. 4, the sub-pixel SPij may include the sub-pixel circuit SPC and the light emitting element LD.

The light emitting element LD may include the anode electrode AE, the cathode electrode CE and a light emitting layer. The light emitting layer may be located between the anode electrode AE and the cathode electrode CE. The anode electrode AE of the light emitting element LD may be electrically connected to the first power supply voltage node VDDN via a second node N2, a first transistor M1, a first node N1 and a third transistor M3, and the cathode electrode CE of the light emitting element LD may be electrically connected to the second power supply voltage node VSSN. The light emitting element LD may generate light of a luminance (e.g., a set or predetermined luminance) in response to an amount of current which is supplied from the first power supply voltage node VDDN to the second power supply voltage node VSSN via the sub-pixel circuit SPC.

The light emitting element LD may be selected as an organic light emitting diode. The light emitting element LD may be selected as an inorganic light emitting diode such as a micro LED (light emitting diode) or a quantum dot light emitting diode. The light emitting element LD may be an element which is composed of a composite of an organic material and an inorganic material. FIG. 4 shows that the sub-pixel SPij includes a single light emitting element LD, but in other embodiments, the sub-pixel SPij may include a plurality of light emitting elements LD and the plurality of light emitting elements LD may be connected to each other in series, parallel or series-parallel.

The sub-pixel circuit SPC may include the first transistor M1, a second transistor M2, the third transistor M3, a fourth transistor M4, a first capacitor C1, a second capacitor C2 and a third capacitor C3.

The first transistor M1 to the fourth transistor M4 may be MOSFETs which include body electrodes. In this case, the first transistor M1 to the fourth transistor M4 may be mounted in a narrow area, and thus, the sub-pixel SPij may be applied to a high-resolution panel.

According to some embodiments, the first transistor M1 to the third transistor M3 may be P-type transistors, and the fourth transistor M4 may be an N-type transistor. The first power supply voltage VDD may be supplied to the body electrode of each of the first transistor M1 to the third transistor M3, and an initialization voltage VINT may be supplied to the body electrode of the fourth transistor M4.

A first electrode of the first transistor M1 may be connected to the first node N1, and a second electrode may be connected to the second node N2. Here, being connected means being electrically connected. The gate electrode of the first transistor M1 may be connected to a third node N3. The first node N1 may mean a node to which a second electrode of the third transistor M3 is connected, and the second node N2 may mean a node to which the anode electrode AE of the light emitting element LD is connected. The first transistor M1 may control an amount of current which is supplied from the first power supply voltage node VDDN to the second power supply voltage node VSSN via the light emitting element LD, in response to the voltage of the third node N3.

The second transistor M2 may be connected between the data line DLj and the third node N3. The gate electrode of the second transistor M2 may be electrically connected to the first sub-gate line SGL1. The second transistor M2 may be turned on when a first scan signal GW is supplied to the first sub-gate line SGL1, to electrically connect the data line DLj and the third node N3.

A first electrode of the third transistor M3 may be electrically connected to the first power supply voltage node VDDN, and the second electrode may be connected to the first node N1. The gate electrode of the third transistor M3 may be electrically connected to the emission control line ELi. The third transistor M3 may be turned off when the emission control signal is supplied (or when the disable emission control signal is supplied) to the emission control line ELi, and may be turned on when the emission control signal is not supplied (or when the enable emission control signal is supplied). When the third transistor M3 is turned off, the first power supply voltage node VDDN and the first node N1 may be electrically disconnected.

A first electrode of the fourth transistor M4 may be connected to the second node N2, and a second electrode may be electrically connected to an initialization voltage node VINTN. The initialization voltage node VINTN may be configured to transfer the initialization voltage VINT. The initialization voltage VINT may be provided by the voltage generator 140 of FIG. 1. The initialization voltage VINT may be set as a voltage by which the light emitting element LD is turned off when the voltage is supplied to the anode electrode AE of the light emitting element LD. The fourth transistor M4 may be turned on when a second scan signal GB is supplied to the second sub-gate line SGL2, to electrically connect the second node N2 and the initialization voltage node VINTN.

The first capacitor C1 may be connected between the first node N1 and the third node N3. The first capacitor C1 may be driven as a coupling capacitor, and may transfer the voltage change of the first node N1 to the third node N3. The first capacitor C1 may store the voltage of the third node N3.

The second capacitor C2 may be connected between the third node N3 and the initialization voltage node VINTN. The second capacitor C2 may store a voltage between the initialization voltage VINT and the third node N3.

A first electrode of the third capacitor C3 may be connected to the third node N3, and a second electrode may be connected to the second node N2. The third capacitor C3 may be driven as a coupling capacitor, and may transmit the voltage change of the second node N2 to the third node N3.

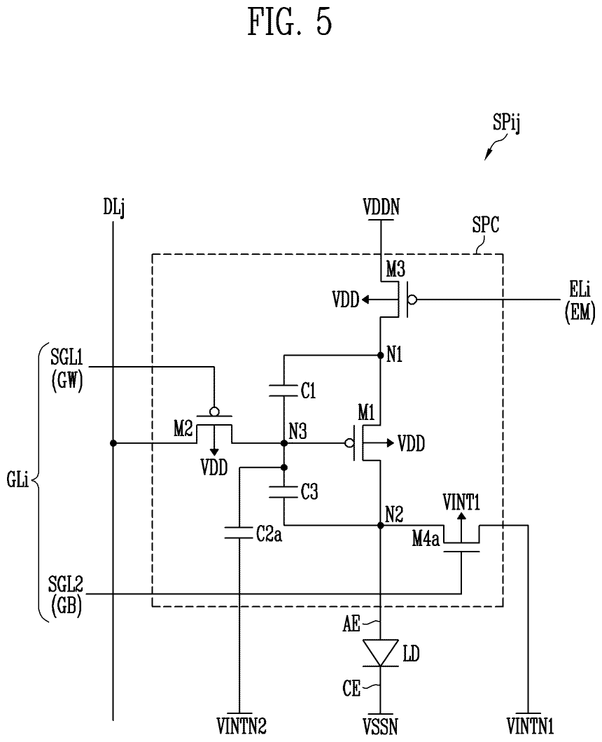

FIG. 5 is a circuit diagram aspects of the sub-pixel of FIG. 2. Although FIG. 5 illustrates various components in a sub-pixel according to some embodiments, embodiments according to the present disclosure are not limited thereto, and according to various embodiments, the sub-pixel may include additional components or fewer components without departing from the spirit and scope of embodiments according to the present disclosure.

In describing FIG. 5 according to some embodiments, the same reference numerals are assigned to the same components as those of FIG. 4, and some repeated descriptions may be omitted.

Referring to FIG. 5, the sub-pixel circuit SPC may include the first transistor M1, the second transistor M2, the third transistor M3, a fourth transistor M4a, the first capacitor C1, a second capacitor C2a and the third capacitor C3.

The fourth transistor M4a may be connected between the second node N2 and a first initialization voltage node (or an auxiliary initialization voltage node) VINTN1. The gate electrode of the fourth transistor M4a may be connected to the second sub-gate line SGL2. The first initialization voltage node VINTN1 may be configured to transfer a first initialization voltage (or an auxiliary initialization voltage) VINT1. The first initialization voltage VINT1 may be provided by the voltage generator 140 of FIG. 1. The first initialization voltage VINT1 may be set as a voltage by which the light emitting element LD is turned off when the voltage is supplied to the anode electrode AE of the light emitting element LD. The first initialization voltage VINT1 may be supplied to the body electrode of the fourth transistor M4a.

The second capacitor C2a may be connected between the third node N3 and a second initialization voltage node (or an initialization voltage node) VINTN2. The second initialization voltage node VINTN2 may be configured to transfer a second initialization voltage (or an initialization voltage). The second initialization voltage may be set as a voltage which is different from the first initialization voltage VINT1. The second capacitor C2a may store a voltage between the second initialization voltage and the third node N3.

The substantial configuration of the sub-pixel SPij shown in FIG. 5 may be the same as that of the sub-pixel SPij of FIG. 4 except that the first initialization voltage VINT1 is supplied to the fourth transistor M4a and the second initialization voltage VINT2 is supplied to the second capacitor C2a.

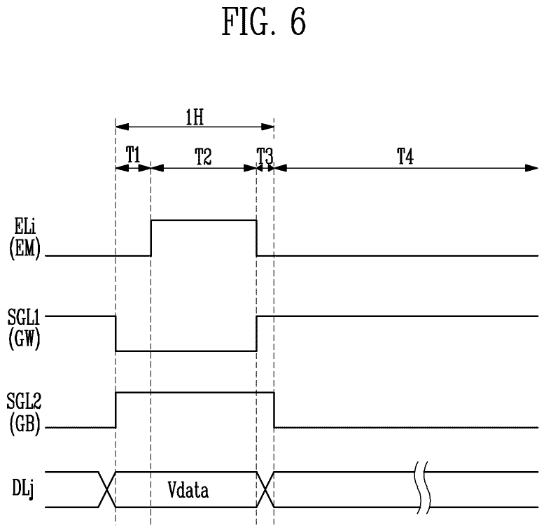

FIG. 6 is a waveform diagram showing aspects of a method for driving the sub-pixel shown in FIGS. 4 and 5 according to some embodiments.

Referring to FIG. 6, a horizontal period (or a specific horizontal period) 1H during which the sub-pixel SPij is driven may be divided into a first period T1, a second period T2 and a third period T3.

The data driver 130 may supply a voltage Vdata of a data signal to the data line DLj during the first period T1 to the third period T3.

The gate driver 120 (or the first gate driver 122) may supply the first scan signal GW to the first sub-gate line SGL1 during the first period T1 and the second period T2. The first scan signal GW may be a logic low level.

The gate driver 120 (or the second gate driver 124) may supply the second scan signal GB to the second sub-gate line SGL2 during the first period T1 to the third period T3. The second scan signal GB may be a logic high level.

The gate driver 120 (or the emission driver 126) may supply the emission control signal EM to the emission control line ELi during the second period T2. The emission control signal EM may be a logic high level.

The first period T1 is a period during which the first power supply voltage VDD is supplied to the first node N1, the initialization voltage VINT is supplied to the second node N2 and the voltage Vdata of the data signal is supplied to the third node N3. During the first period T1, the light emitting element LD may be initialized. During the first period T1, the first capacitor C1, the second capacitor C2 and the third capacitor C3 may be initialized. This first period T1 may be named an initialization period.

The second period T2 is a period during which the initialization voltage VINT is supplied to the second node N2 and the voltage Vdata of the data signal is supplied to the third node N3. During the second period T2, a voltage corresponding to the threshold voltage of the first transistor M1 may be stored in the first capacitor C1. This second period T2 may be named a data writing/threshold voltage compensation period.

During the third period T3, the first transistor M1 may control an amount of current which is supplied from the first power supply voltage VDD to the initialization voltage VINT, in response to the voltage of the third node N3. In this case, it is possible to prevent unnecessary current from being supplied to the light emitting element LD after the second period T2. This third period T3 may be named a luminance control period.

During a fourth period T4, the first transistor M1 may control an amount of current which is supplied from the first power supply voltage node VDDN to the second power supply voltage node VSSN via the light emitting element LD, in response to the voltage of the third node N3. During the fourth period T4, the light emitting element LD may emit light with a luminance corresponding to an amount of current supplied from the first transistor M1. This fourth period T4 may be named a light emitting period.

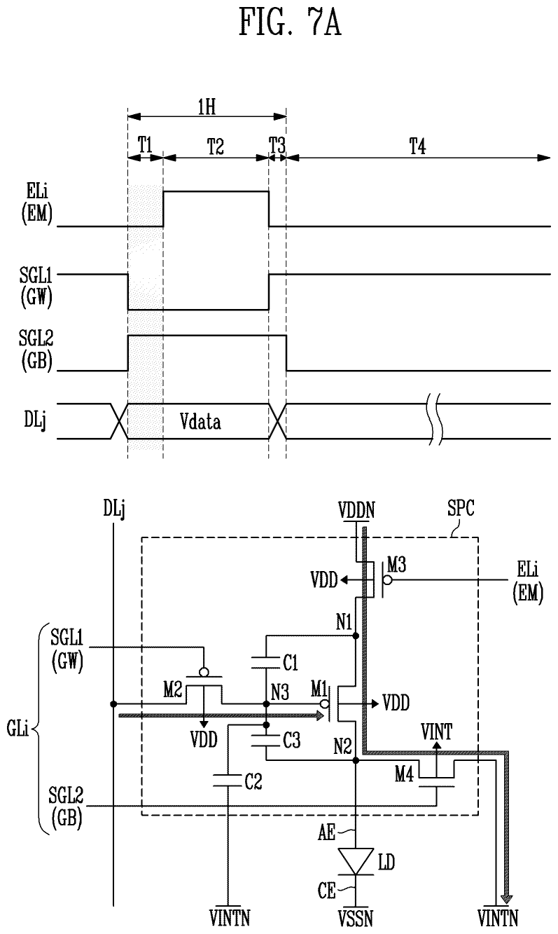

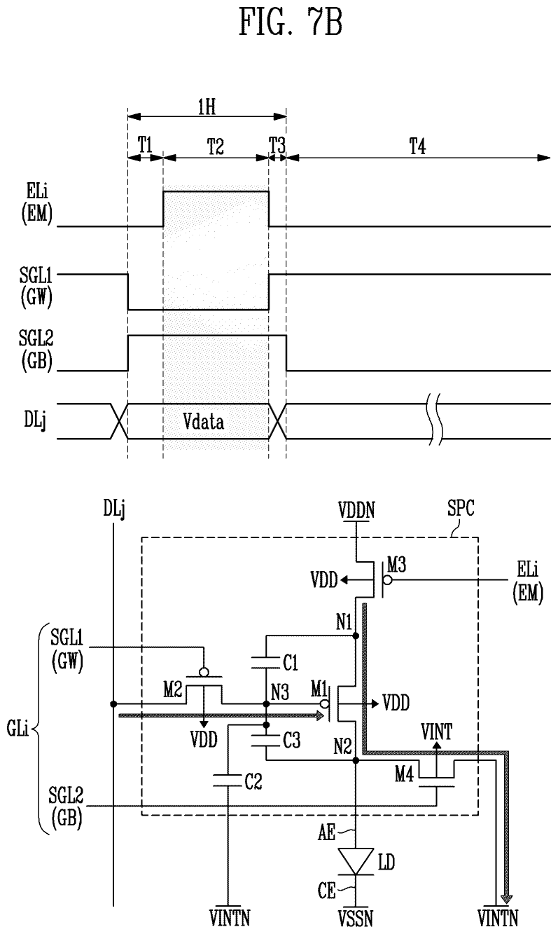

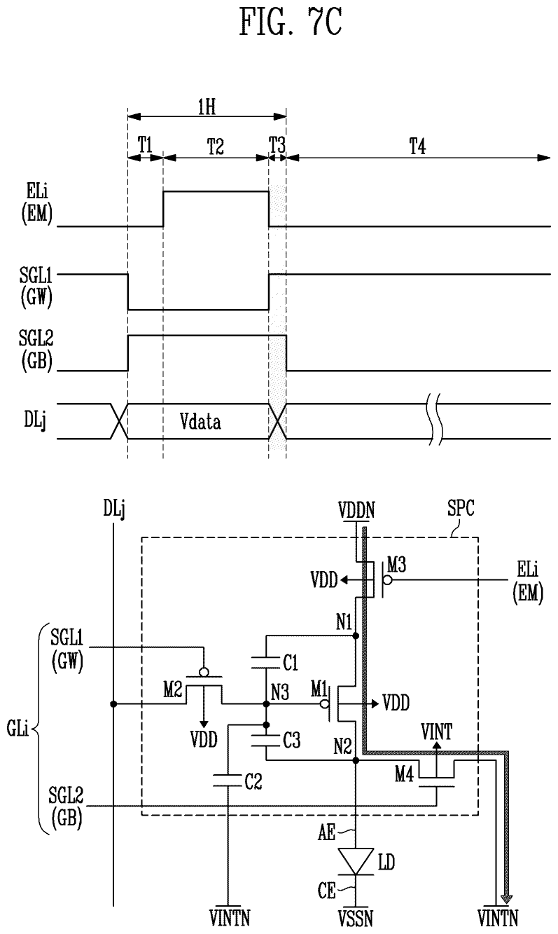

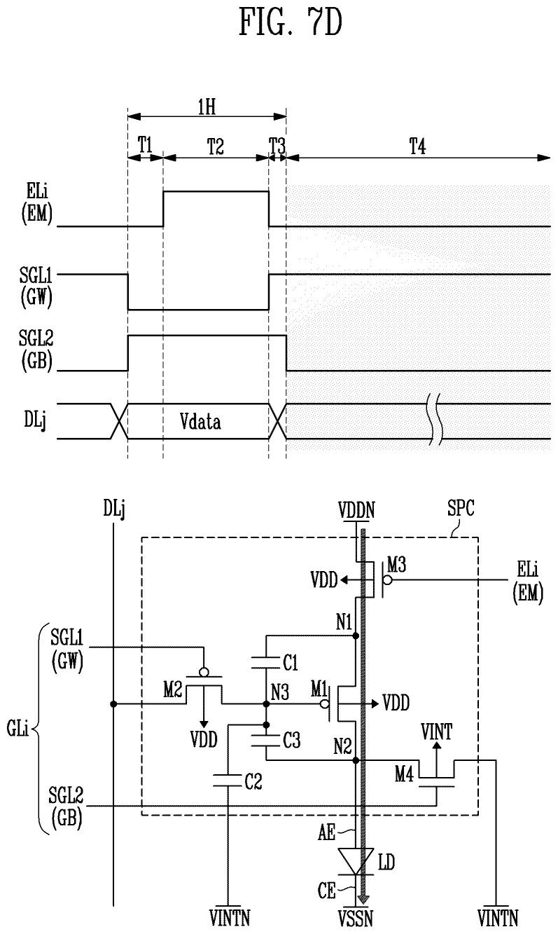

FIGS. 7A to 7D are diagrams showing aspects of an operation process of a sub-pixel corresponding to driving waveforms of FIG. 6 according to some embodiments. In FIGS. 7A to 7D, the operation process will be described using the sub-pixel SPij shown in FIG. 4, but the operation of the sub-pixel SPij shown in FIG. 5 may also be substantially the same.

Referring to FIG. 7A, during the first period T1, the first scan signal GW is supplied to the first sub-gate line SGL1, and the second scan signal GB is supplied to the second sub-gate line SGL2. In addition, during the first period T1, the enable emission control signal EM is supplied to the emission control line ELi, and accordingly, the third transistor M3 is set to a turned-on state. When the third transistor M3 is set to the turned-on state, the first power supply voltage VDD may be supplied to the first node N1.

As the first scan signal GW is supplied to the first sub-gate line SGL1, the second transistor M2 is turned on. When the second transistor M2 is turned on, the voltage Vdata of the data signal is supplied from the data line DLj to the third node N3.

The first capacitor C1 may be initialized by the voltage Vdata of the data signal and the first power supply voltage VDD. For example, the first capacitor C1 may be charged with a voltage corresponding to the voltage Vdata of the data signal and the first power supply voltage VDD during the first period T1, regardless of a voltage charged during a previous period (or a previous frame period).

The second capacitor C2 may be initialized by the voltage Vdata of the data signal and the initialization voltage VINT. For example, the second capacitor C2 may be charged with a voltage corresponding to the voltage Vdata of the data signal and the initialization voltage VINT during the first period T1, regardless of a voltage charged during the previous period (or the previous frame period).

As the second scan signal GB is supplied to the second sub-gate line SGL2, the fourth transistor M4 is turned on. When the fourth transistor M4 is turned on, the initialization voltage VINT is supplied to the second node N2. When the initialization voltage VINT is supplied to the second node N2, the light emitting element LD may be initialized. For example, when the initialization voltage VINT is supplied to the second node N2, the parasitic capacitor of the light emitting element LD may be discharged.

The third capacitor C3 may be initialized by the voltage Vdata of the data signal supplied to the third node N3 and the initialization voltage VINT supplied to the second node N2. For example, the third capacitor C3 may be charged with a voltage corresponding to the voltage Vdata of the data signal and the initialization voltage VINT during the first period T1, regardless of a voltage charged during the previous period (or the previous frame period).

During the first period T1, current supplied from the first transistor M1 may be supplied to the initialization voltage node VINTN via the fourth transistor M4. Therefore, during the first period T1, the light emitting element LD may maintain a non-emission state.

Referring to FIG. 7B, during the second period T2, the second transistor M2 may maintain the turned-on state by the first scan signal GW supplied to the first sub-gate line SGL1, and the fourth transistor M4 may maintain the turned-on state by the second scan signal GB supplied to the second sub-gate line SGL2.

During the second period T2, the third transistor M3 may be turned off by the emission control signal (or the disable emission control signal) EM supplied to the emission control line ELi. When the third transistor M3 is turned off, the first power supply voltage node VDDN and the first node N1 may be electrically disconnected.

During the second period T2, because the second transistor M2 is set to the turned-on state, the voltage Vdata of the data signal is supplied to the third node N3 from the data line DLj. In this case, the voltage of the first node N1 may fall from the first power supply voltage VDD to a voltage Vdata+|VthM1| which is obtained by summing the voltage Vdata of the data signal and the absolute threshold voltage of the first transistor M1.

That is to say, during the second period T2, the third node N3 may be set to the voltage Vdata of the data signal, and the first node N1 may be set to the voltage Vdata+|VthM1| which is obtained by summing the voltage Vdata of the data signal and the absolute threshold voltage of the first transistor M1. Therefore, during the second period T2, the threshold voltage of the first transistor M1 may be stored in the first capacitor C1.

During the second period T2, because the fourth transistor M4 is set to the turned-on state, current supplied from the first node N1 to the second node N2 via the first transistor M1 may be supplied to the initialization voltage node VINTN via the fourth transistor M4. Therefore, during the second period T2, the light emitting element LD may maintain the non-emission state.

Referring to FIG. 7C, during the third period T3, the enable emission control signal EM may be supplied to the emission control line ELi, and accordingly, the third transistor M3 may be set to a turned-on state. During the third period T3, the supply of the first scan signal GW to the first sub-gate line SGL1 is stopped, and accordingly, the second transistor M2 may be set to a turned-off state. During the third period T3, the second scan signal GB is supplied to the second sub-gate line SGL2, and accordingly, the fourth transistor M4 maintains the turned-on state.

During the third period T3, because the third transistor M3 is set to the turned-on state, the first transistor M1 controls an amount of current which is supplied from the first power supply voltage VDD to the second node N2, in response to the voltage of the third node N3. Because the fourth transistor M4 is set to the turned-on state, current supplied to the second node N2 may be supplied to the initialization voltage node VINTN. In other words, during the third period T3, the light emitting element LD may be set to the non-emission state, and accordingly, the grayscale expression capability of the display device 100 may be relatively improved.

According to some embodiments, during the second period T2, the voltage of the second node N2 may rise to a voltage higher than a desired voltage, and thus, unnecessary current may be supplied to the light emitting element LD. For example, even when a black grayscale is implemented in the sub-pixel SPij, the light emitting element LD may temporarily emit light. Therefore, according to some embodiments of the present disclosure, during the third period T3, current supplied from the first transistor M1 may be supplied to the initialization voltage VINT, and accordingly, the grayscale expression capability of the display device 100 may be relatively improved.

During the third period T3, the voltage of the first node N1 may be changed from the voltage Vdata+|VthM1|, which is obtained by summing the voltage Vdata of the data signal and the absolute threshold voltage of the first transistor M1, to the first power supply voltage VDD. Accordingly, the voltage change of the first node N1 may be expressed as in Mathematical Expression 1.

$$Δ VN 1 = ELVDD - ( Vdata + \vert Vth \vert ) \qquad Mathematical Expression 1$$

In Mathematical Expression 1, ΔVN1 may represent the voltage change of the first node N1. When the voltage of the first node N1 changes as in Mathematical Expression 1 during the third period T3, the voltage of the third node N3 may change as in Mathematical Expression 2 due to coupling of the first capacitor C1.

$$VN 3 = Vdata + α \times Δ VN 1 \\ α = \frac{C 1}{C 1 + C 2 + C 3} \qquad Mathematical Expression 2$$

In Mathematical Expression 2, VN3 may represent the voltage of the third node N3. The voltage of the third node N3 may change by a value obtained by multiplying the voltage change of the first node N1 by the ratio of the capacitors C1, C2 and C3 (e.g., C1/C1+C2+C3).

Referring to FIG. 7D, during the fourth period T4, the supply of the second scan signal GB to the second sub-gate line SGL2 is stopped, and accordingly, the fourth transistor M4 may be turned off. During the fourth period T4, the first scan signal GW is not supplied to the first sub-gate line SGL1, and accordingly, the second transistor M2 maintains the turned-off state. During the fourth period T4, the enable emission control signal EM is supplied to the emission control line ELi, and accordingly, the third transistor M3 may maintain the turned-on state.

The first transistor M1 controls an amount of current which is supplied from the first power supply voltage node VDDN to the second power supply voltage node VSSN via the light emitting element LD, in response to the voltage of the third node N3. During the fourth period T4, the light emitting element LD may generate light with a luminance corresponding to an amount of driving current supplied from the first transistor M1.

During the fourth period T4, the voltage of the second node N2 may change from the initialization voltage VINT to a voltage (e.g., a set or predetermined voltage). The voltage change of the second node N2 during the fourth period T4 may be expressed as in Mathematical Expression 3.

$$Δ VN 2 = VN 2 - VINT \qquad Mathematical Expression 3$$

In Mathematical Expression 3, ΔVN2 may represent the voltage change of the second node N2, and VN2 may represent the voltage of the second node N2 during the fourth period T4. When the voltage of the second node N2 changes as in Mathematical Expression 3 during the fourth period T4, the voltage of the third node N3 may change as in Mathematical Expression 4 due to coupling of the third capacitor C3.

$$VN 3 = Vdata + α \times Δ VN 1 + β \times Δ VN 2 \\ β = \frac{C 3}{C 1 + C 2 + C 3} \qquad Mathematical Expression 4$$

Referring to Mathematical Expression 4, the voltage of the third node N3 may change by a value obtained by multiplying the voltage change of the second node N2 by the ratio of the capacitors C1, C2 and C3 (e.g., C3/C1+C2+C3).

In this case, a Vsg voltage of the first transistor M1 may be expressed as in Mathematical Expression 5.

$$Vsg = VDD - ( Vdata + α \times Δ VN 1 + β \times Δ VN 2 ) \qquad Mathematical Expression 5$$

The threshold voltage of the first transistor M1 may be set differently in correspondence to the voltage difference (e.g., VBS) between the body electrode and the source electrode. When assuming that the first power supply voltage VDD is set to 8V, during the second period T2, the body electrode of the first transistor M1 may be set to 8V, and the source electrode (i.e., the first node N1) may be set to a voltage lower than the body electrode. For example, assuming that the first node N1 is set to 4V, the voltage difference between the body electrode and the source electrode of the first transistor M1 may be set to 4V (e.g., VBS=4V). At this time, the first transistor M1 may have a first threshold voltage. During the second period T2, the first threshold voltage may be compensated. The first threshold voltage may be Vth described in Mathematical Expression 1.

During the fourth period T4, the first node N1 is set to the first power supply voltage VDD. In this case, the body electrode and the source electrode of the first transistor M1 are set to the same voltage (i.e., VBS=0), and the first transistor M1 may have a second threshold voltage different from the first threshold voltage. The second threshold voltage may be denoted as Vth′.

Therefore, driving current Id which is supplied from the first transistor M1 to the light emitting element LD during the fourth period T4 may be expressed as in Mathematical Expression 6.

$$Mathematical Expression 6$$

$$Id = \frac{1}{2} μ Cox \frac{W}{L} {\{ \frac{C 2 + C 3}{C 1 + C 2 + C 3} ( VDD - Vdata ) + \frac{C 1}{C 1 + C 2 + C 3} \vert Vth \vert - \\ \frac{C 3}{C 1 + C 2 + C 3} ( VN 2 - VINT ) - \vert {Vth}^{′} \vert \}}^{2}$$

In Mathematical Expression 6, μ may mean the electron mobility of the first transistor M1, Cox may mean the oxide capacitance of the first transistor M1, W may mean the channel width of the first transistor M1, and L may mean the channel length of the first transistor M1.

Referring to Mathematical Expression 6, the voltage Vdata of the data signal may be reflected in the driving current Id as a value multiplied by the ratio of the capacitors (e.g., C2+C3/C1+C2+C3). When the voltage Vdata of the data signal is reflected in the driving current Id in correspondence to the ratio of the capacitors (e.g., C2+C3/C1+C2+C3), the voltage range of the data signal may be widened.

For example, when the voltage Vdata of the data signal is directly reflected in the driving current Id, the voltage range of the data signal is set to be low. In this case, a grayscale is implemented using the data signal of a low voltage range, and thus, it is difficult to stably implement a desired grayscale. On the other hand, when the voltage range of the data signal is set to be wide as in the embodiments of the present disclosure, a grayscale may be stably implemented.

In addition, the threshold voltages Vth and Vth′ of the first transistor M1 may be reflected in the driving current Id in correspondence to the ratios of the capacitors (e.g., C1/C1+C2+C3 and C3/C1+C2+C3). In this case, the influence of the threshold voltages Vth and Vth′ of the first transistor M1 may be minimized.

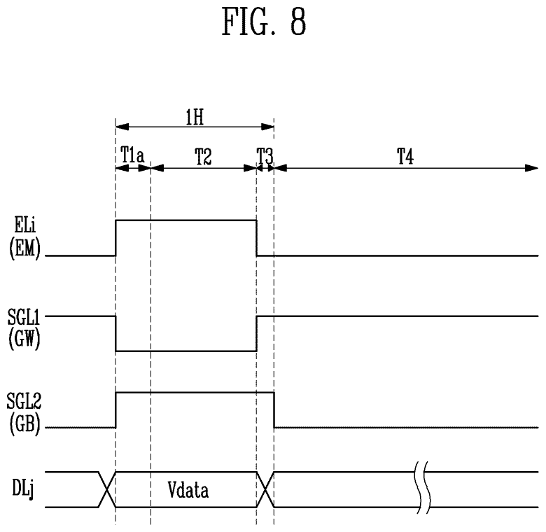

FIG. 8 is a waveform diagram showing aspects of a method for driving the sub-pixel shown in FIGS. 4 and 5 according to some embodiments. In describing FIG. 8, some description overlapping the description of FIG. 6 may be omitted.

Referring to FIG. 8, a horizontal period (or a specific horizontal period) 1H during which the sub-pixel SPij is driven may be divided into a first period T1a, a second period T2 and a third period T3.

The data driver 130 may supply a voltage Vdata of a data signal to the data line DLj during the first period T1a to the third period T3.

The gate driver 120 (or the first gate driver 122) may supply the first scan signal GW to the first sub-gate line SGL1 during the first period T1a and the second period T2. The first scan signal GW may be a logic low level.

The gate driver 120 (or the second gate driver 124) may supply the second scan signal GB to the second sub-gate line SGL2 during the first period T1a to the third period T3. The second scan signal GB may be a logic high level.

The gate driver 120 (or the emission driver 126) may supply the emission control signal EM to the emission control line ELi during the first period T1a and the second period T2. The emission control signal EM may be a logic high level.

When the emission control signal EM is supplied to the emission control line ELi during the first period T1a, the third transistor M3 may be turned off during the first period T1a. During the first period T1a, the initialization voltage VINT may be supplied to the second node N2, and the voltage Vdata of the data signal may be supplied to the third node N3. During the first period T1a, the voltage of the first node N1 may gradually fall from the first power supply voltage VDD. For example, during the first period T1a (and the second period T2), the voltage of the first node N1 may fall from the first power supply voltage VDD to a voltage Vdata+|VthM1| which is obtained by summing the voltage Vdata of the data signal and the absolute threshold voltage of the first transistor M1.

Namely, in FIG. 8, the threshold voltage of the first transistor M1 is additionally compensated during the first period T1a in the method for driving the sub-pixel shown in FIGS. 4 and 5, and a substantial operation process may be the same as the driving method of FIG. 6.

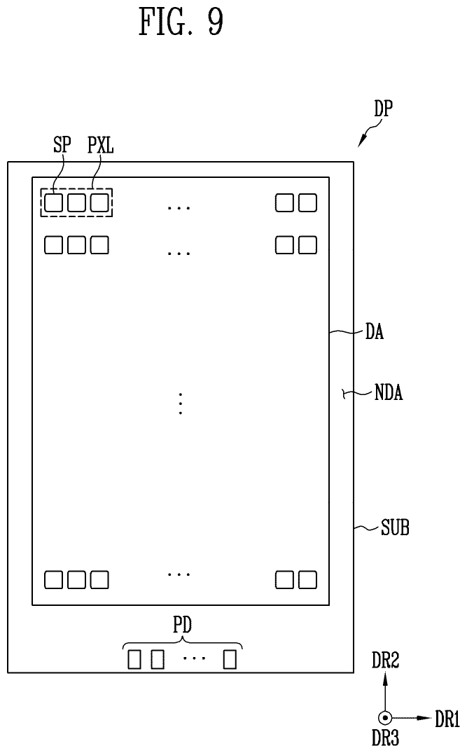

FIG. 9 is a plan view showing aspects of a display panel of FIG. 1 according to some embodiments.

Referring to FIG. 9, an embodiment DP of the display panel 110 of FIG. 1 may include a display area DA and a non-display area NDA. The display panel DP displays images through the display area DA. The non-display area NDA is arranged around (e.g., in a periphery or outside a footprint of) the display area DA.

The display panel DP may include a substrate SUB, sub-pixels SP and pads PD.

When the display panel DP may be used as the display screen of a head-mounted display (HMD), a virtual reality (VR) device, a mixed reality (MR) device, an augmented reality (AR) device or the like, the display panel DP may be positioned very close to a user's eyes. In this case, the sub-pixels SP with relatively high degree of integration are required. In order to increase the degree of integration of the sub-pixels SP, the substrate SUB may be provided as a silicon substrate. The sub-pixels SP and/or the display panel DP may be formed on the substrate SUB which is a silicon substrate. The display device 100 (see FIG. 1) including the display panel DP formed on the substrate SUB which is a silicon substrate may be referred to as an OLEDOS (OLED on silicon) display device.

The sub-pixels SP are located in the display area DA on the substrate SUB. The sub-pixels SP may be arranged in a matrix form in a first direction DR1 and a second direction DR2 intersecting the first direction DR1. However, embodiments are not limited thereto. For example, the sub-pixels SP may be arranged in a zigzag pattern in the first direction DR1 and the second direction DR2. For example, the sub-pixels SP may be arranged in a PENTILE™ pattern or arrangement. The first direction DR1 may be a row direction, and the second direction DR2 may be a column direction.

Two or more sub-pixels SP among a plurality of sub-pixels SP may form one pixel PXL.

Components for controlling the sub-pixels SP may be located in the non-display area NDA on the substrate SUB. For example, wirings which are connected to the sub-pixels SP, such as the first to mth gate lines GL1 to GLm and the first to nth data lines DL1 to DLn of FIG. 1, may be located in the non-display area NDA.

At least one of the gate driver 120, the data driver 130, the voltage generator 140, the controller 150, or the temperature sensor 160 of FIG. 1 may be integrated in the non-display area NDA of the display panel DP. According to some embodiments, the gate driver 120 of FIG. 1 may be mounted in the display panel DP, and may be located in the non-display area NDA. In other embodiments, the gate driver 120 may be implemented as an integrated circuit which is separate from the display panel DP. According to some embodiments, the temperature sensor 160 may be located in the non-display area NDA to sense the temperature of the display panel DP.

The pads PD are located in the non-display area NDA on the substrate SUB. The pads PD may be electrically connected to the sub-pixels SP via wirings. For example, the pads PD may be connected to the sub-pixels SP through the first to nth data lines DL1 to DLn.

The pads PD may interface the display panel DP to other components of the display device 100 (see FIG. 1). According to some embodiments, voltages and signals which are necessary for the operations of components included in the display panel DP may be provided through the pads PD from the driver integrated circuit DIC of FIG. 1. For example, the first to nth data lines DL1 to DLn may be connected to the driver integrated circuit DIC through the pads PD. For example, the first and second power supply voltages VDD and VSS may be received through the pads PD from the voltage generator 140. For example, when the gate driver 120 is mounted in the display panel DP, the gate control signal GCS may be transmitted to the gate driver 120 through the pads PD from the driver integrated circuit DIC.

According to some embodiments, a circuit board may be electrically connected to the pads PD using a conductive adhesive member such as an anisotropic conductive film. The circuit board may be a flexible printed circuit board (FPCB) or a flexible film which is made of a flexible material. The driver integrated circuit DIC may be mounted on the circuit board to be electrically connected to the pads PD.

According to some embodiments, the display area DA may have various shapes. The display area DA may have the shape of a closed loop including straight and/or curved sides. For example, the display area DA may have shapes such as a polygon, a circle, a semicircle and an ellipse.

According to some embodiments, the display panel DP may have a flat display surface. In other embodiments, the display panel DP may have an at least partially round display surface. According to some embodiments, the display panel DP may be bendable, foldable or rollable. In these cases, the display panel DP and/or the substrate SUB may include materials which have flexible properties.

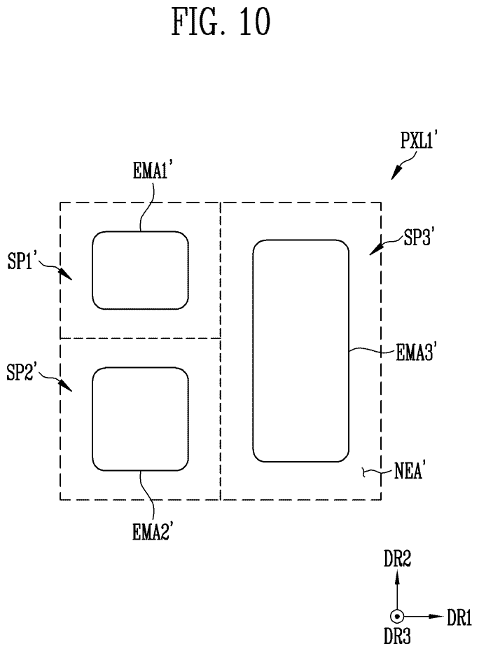

FIG. 10 is a plan view showing aspects of any one of pixels of FIG. 9 according to some embodiments.

Referring to FIG. 10, a first pixel PXL1′ may include first to third sub-pixels SP1′ to SP3′.

The first sub-pixel SP1′ may include a first emitting area EMA1′ and a non-emitting area NEA′ around the first emitting area EMA1′. The second sub-pixel SP2′ may include a second emitting area EMA2′ and a non-emitting area NEA′ around the second emitting area EMA2′. The third sub-pixel SP3′ may include a third emitting area EMA3′ and a non-emitting area NEA′ around the third emitting area EMA3′.

The first sub-pixel SP1′ and the second sub-pixel SP2′ may be arranged in the second direction DR2. The third sub-pixel SP3′ may be arranged in the first direction DR1 with respect to each of the first and second sub-pixels SP1′ and SP2′.

The second sub-pixel SP2′ may have a larger area than the first sub-pixel SP1′, and the third sub-pixel SP3′ may have a larger area than the second sub-pixel SP2′. Accordingly, the second emitting area EMA2′ may have a larger area than the first emitting area EMA1′, and the third emitting area EMA3′ may have a larger area than the second emitting area EMA2′. However, embodiments are not limited thereto. For example, the first and second sub-pixels SP1′ and SP2′ may have substantially the same area as each other, and the third sub-pixel SP3′ may have a larger area than each of the first and second sub-pixels SP1′ and SP2′. In this way, the areas of the first to third sub-pixels SP1′ to SP3′ may be changed in various ways according to embodiments.

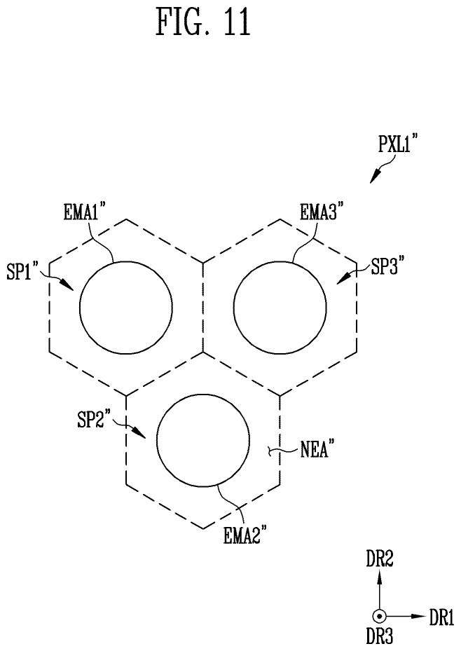

FIG. 11 is a plan view showing aspects of any one of pixels of FIG. 9 according to some embodiments.

Referring to FIG. 11, a first sub-pixel SP1″ may include a first emitting area EMA1″ and a non-emitting area NEA″ around the first emitting area EMA1″. A second sub-pixel SP2″ may include a second emitting area EMA2″ and a non-emitting area NEA″ around the second emitting area EMA2″. A third sub-pixel SP3″ may include a third emitting area EMA3″ and a non-emitting area NEA″ around the third emitting area EMA3″.

The first to third sub-pixels SP1″ to SP3″ may have polygonal shapes when viewed in a third direction DR3. For example, the shapes of the first to third sub-pixels SP1″ to SP3″ may be hexagons as shown in FIG. 11.

The first to third emitting areas EMA1″ to EMA3″ may have circular shapes when viewed in the third direction DR3. However, embodiments are not limited thereto. For example, each of the first to third emitting areas EMA1″ to EMA3″ may have a polygonal shape.

The first and third sub-pixels SP1″ and SP3″ may be arranged in the first direction DR1. The second sub-pixel SP2″ may be arranged in a direction inclined by an acute angle from the second direction DR2 (or a diagonal direction) with respect to the first sub-pixel SP1″.

The arrangement of the sub-pixels SP1″ to SP3″ represents an example, and embodiments are not limited thereto. Each pixel may include two or more sub-pixels, the sub-pixels may be arranged in various ways, each of the sub-pixels may have various shapes, and each of emitting areas of the sub-pixels may also have various shapes.

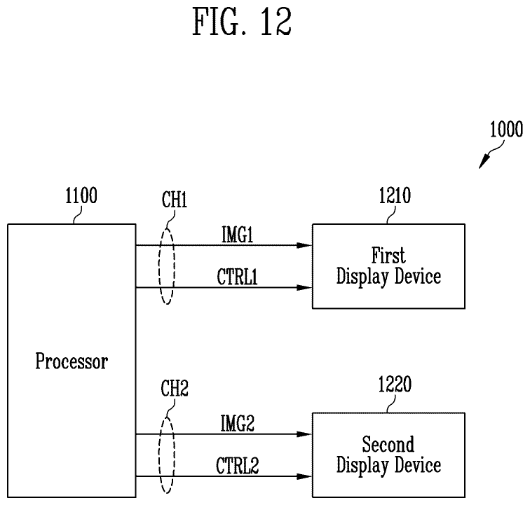

FIG. 12 is a block diagram showing aspects of a display system according to some embodiments.

Referring to FIG. 12, a display system 1000 may include a processor 1100 and one or more display devices 1210 and 1220.

The processor 1100 may perform various tasks and calculations. According to some embodiments, the processor 1100 may include an application processor, a graphic processor, a microprocessor, a central processing unit (CPU), or the like. The processor 1100 may be connected to other components of the display system 1000 through a bus system to control the components.

FIG. 12 shows that the display system 1000 includes first and second display devices 1210 and 1220. The processor 1100 may be connected to the first display device 1210 through a first channel CH1, and may be connected to the second display device 1220 through a second channel CH2.

Through the first channel CH1, the processor 1100 may transmit first image data IMG1 and a first control signal CTRL1 to the first display device 1210. The first display device 1210 may display an image on the basis of the first image data IMG1 and the first control signal CTRL1. The first display device 1210 may be configured in the same manner as the display device 100 described above with reference to FIG. 1. In this case, the first image data IMG1 and the first control signal CTRL1 may be provided as the input image data IMG and the control signal CTRL, respectively, of FIG. 1.

Through the second channel CH2, the processor 1100 may transmit second image data IMG2 and a second control signal CTRL2 to the second display device 1220. The second display device 1220 may display an image on the basis of the second image data IMG2 and the second control signal CTRL2. The second display device 1220 may be configured in the same manner as the display device 100 described above with reference to FIG. 1. In this case, the second image data IMG2 and the second control signal CTRL2 may be provided as the input image data IMG and the control signal CTRL, respectively, of FIG. 1.

The display system 1000 may include a computing system which provides an image display function, such as a portable computer, a mobile phone, a smart phone, a tablet personal computer, a smart watch, a watch phone, a portable multimedia player (PMP), a navigation and an ultra mobile personal computer (UMPC). The display system 1000 may include at least one among a head-mounted display (HMD), a virtual reality (VR) device, a mixed reality (MR) device and an augmented reality (AR) device.

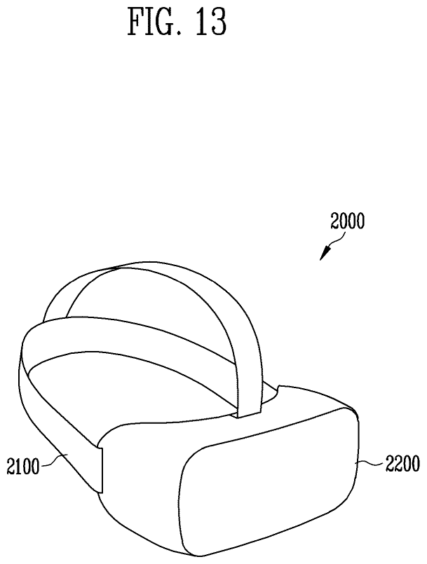

FIG. 13 is a perspective view showing an application example of the display system of FIG. 12.

Referring to FIG. 13, the display system 1000 of FIG. 12 may be applied to a head-mounted display 2000. The head-mounted display 2000 may be a wearable electronic device which may be worn on a user's head.

The head-mounted display 2000 may include a head-mounting band 2100 and a display device reception case 2200. The head-mounting band 2100 may be connected to the display device reception case 2200. The head-mounting band 2100 may include a horizontal band and/or a vertical band for securing the head-mounted display 2000 to the user's head. The horizontal band may be configured to surround the side of the user's head, and the vertical band may be configured to surround the top of the user's head. However, embodiments are not limited thereto. For example, the head-mounted band 2100 may be implemented in the form of a glass frame, a helmet, etc.

The display device reception case 2200 may receive the first and second display devices 1210 and 1220 of FIG. 12. The display device reception case 2200 may further receive the processor 1100 of FIG. 12.

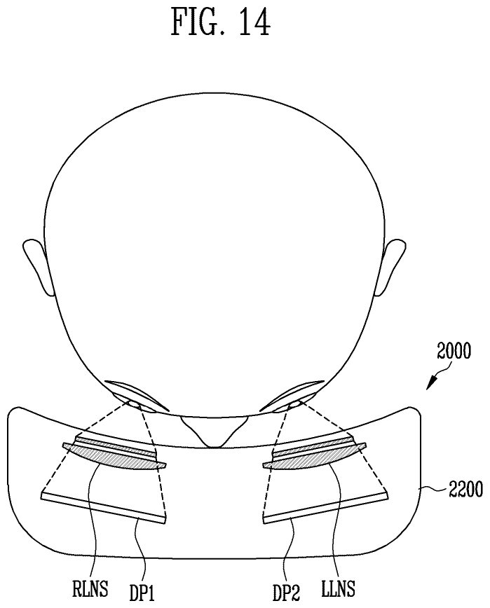

FIG. 14 is a diagram showing a head-mounted display worn by a user.

Referring to FIG. 14, in the head-mounted display 2000, a first display panel DP1 of the first display device 1210 and a second display panel DP2 of the second display device 1220 are located. The head-mounted display 2000 may further include one or more lenses LLNS and RLNS.

In the display device reception case 2200, the right eye lens RLNS may be located between the first display panel DP1 and the user's right eye. In the display device reception case 2200, the left eye lens LLNS may be located between the second display panel DP2 and the user's left eye.

An image outputted from the first display panel DP1 may be shown to the user's right eye through the right eye lens RLNS. The right eye lens RLNS may refract light from the first display panel DP1 toward the user's right eye. The right eye lens RLNS may perform an optical function to adjust the viewing distance between the first display panel DP1 and the user's right eye.

An image outputted from the second display panel DP2 may be shown to the user's left eye through the left eye lens LLNS. The left eye lens LLNS may refract light from the second display panel DP2 toward the user's left eye. The left eye lens LLNS may perform an optical function to adjust the viewing distance between the second display panel DP2 and the user's left eye.

According to some embodiments, each of the right eye lens RLNS and the left eye lens LLNS may include an optical lens which has a pancake-shaped cross-section. According to some embodiments, each of the right eye lens RLNS and the left eye lens LLNS may include a multi-channel lens which includes sub-areas with different optical properties. In this case, each display panel outputs images corresponding to the sub-areas, respectively, of the multi-channel lens, and the outputted images may be shown to the user by passing through the corresponding sub-areas, respectively.

Although aspects of some embodiments and application examples have been described herein, other embodiments and variations may be derived from the above descriptions. Accordingly, the spirit and scope of embodiments according to the present disclosure are not limited to these embodiments, but extends to the claims set forth below, various obvious modifications and equivalents.

What is claimed is:

1. A sub-pixel comprising:
a first transistor having a first electrode connected via a first node to a first power supply voltage node configured to receive a first power supply voltage, a second electrode connected to a second node, and a gate electrode connected to a third node;
a light emitting element connected between the second node and a second power supply voltage node configured to receive a second power supply voltage;
a second transistor connected between a data line and the third node, and having a gate electrode which is connected to a first sub-gate line;
a first capacitor connected between the first node and the third node;
a second capacitor connected between an initialization voltage node configured to receive an initialization voltage and the third node; and
a third capacitor connected between the third node and the second node.

2. The sub-pixel of claim 1, further comprising:
a third transistor connected between the first power supply voltage node and the first node, and having a gate electrode connected to an emission control line.

3. The sub-pixel of claim 2, further comprising:
a fourth transistor connected between the second node and the initialization voltage node, and having a gate electrode connected to a second sub-gate line.

4. The sub-pixel of claim 3, wherein the first transistor, the second transistor and the third transistor are P-type transistors, and the fourth transistor is an N-type transistor.

5. The sub-pixel of claim 4, wherein
each of the first to fourth transistors includes a body electrode, and
the body electrode of each of the first to third transistors are configured to receive the first power supply voltage, and the body electrode of the fourth transistor is configured to receive the initialization voltage.

6. The sub-pixel of claim 3, wherein
one horizontal period is divided into a first period, a second period, and a third period,
the second transistor is turned on during the first period and the second period,
the fourth transistor is turned on during the first period to the third periods, and
the third transistor is turned off during the second period.

7. The sub-pixel of claim 6, wherein the data line is configured to receive a voltage of a data signal during the first period to the third period.

8. The sub-pixel of claim 6, wherein the third transistor is configured to be turned off during the first period.

9. The sub-pixel of claim 3, wherein the initialization voltage is a voltage by which the light emitting element is configured to be turned off based on the voltage being supplied to the light emitting element.

10. The sub-pixel of claim 2, further comprising:
a fourth transistor connected between the second node and an auxiliary initialization voltage node configured to receive an auxiliary initialization voltage, and having a gate electrode connected to a second sub-gate line,
wherein the auxiliary initialization voltage is a voltage which is different from the initialization voltage.

11. A display device comprising:
sub-pixels connected to data lines, gate lines, and emission control lines;
a gate driver configured to drive the gate lines and the emission control lines; and
a data driver configured to drive the data lines,
each of the sub-pixels comprising:
a first transistor having a first electrode connected via a first node to a first power supply voltage node configured to receive a first power supply voltage, a second electrode connected to a second node, and a gate electrode connected to a third node;
a light emitting element connected between the second node and a second power supply voltage node configured to receive a second power supply voltage;
a second transistor connected between a data line which is any one of the data lines and the third node, and having a gate electrode connected to a first sub-gate line which is any one of the gate lines;
a first capacitor connected between the first node and the third node;
a second capacitor connected between an initialization voltage node to which an initialization voltage is inputted and the third node; and
a third capacitor connected between the third node and the second node.

12. The display device of claim 11, wherein each of the sub-pixels further comprises a third transistor connected between the first power supply voltage node and the first node and having a gate electrode connected to an emission control line which is any one of the emission control lines.

13. The display device of claim 12, wherein each of the sub-pixels further comprises a fourth transistor connected between the second node and the initialization voltage node and having a gate electrode which is connected to a second sub-gate line which is any one of the gate lines.

14. The display device of claim 13, wherein the first transistor, the second transistor and the third transistor are P-type transistors, and the fourth transistor is an N-type transistor.

15. The display device of claim 14, wherein
each of the first to fourth transistors includes a body electrode, and
the body electrode of each of the first to third transistors are configured to receive the first power supply voltage, and the body electrode of the fourth transistor is configured to receive the initialization voltage.

16. The display device of claim 13, wherein
one horizontal period is divided into a first period, a second period, and a third period, and
the gate driver is configured to supply a first scan signal with a gate-on voltage to the first sub-gate line during the first period and the second period, to supply a second scan signal with a gate-on voltage to the second sub-gate line during the first period to the third period, and to supply an emission control signal with a gate-off voltage to the emission control line during the second period.

17. The display device of claim 16, wherein the data driver is configured to supply a voltage of a data signal to the data line during the first period to the third period.

18. The display device of claim 16, wherein the gate driver is further configured to supply the emission control signal to the emission control line during the first period.

19. The display device of claim 12, wherein
each of the sub-pixels further comprises a fourth transistor connected between the second node and an auxiliary initialization voltage node to which an auxiliary initialization voltage is supplied and having a gate electrode which is connected to a second sub-gate line which is any one of the gate lines, and
the auxiliary initialization voltage is a voltage which is different from the initialization voltage.

20. An electronic device, comprising a processor to provide image data;
a display device to display an image based on the image data; and
wherein the display device, comprising:
sub-pixels connected to data lines, gate lines, and emission control lines;
a gate driver configured to drive the gate lines and the emission control lines; and
a data driver configured to drive the data lines,
each of the sub-pixels comprising:
a first transistor having a first electrode connected via a first node to a first power supply voltage node configured to receive a first power supply voltage, a second electrode connected to a second node, and a gate electrode connected to a third node;
a light emitting element connected between the second node and a second power supply voltage node configured to receive a second power supply voltage;
a second transistor connected between a data line which is any one of the data lines and the third node, and having a gate electrode connected to a first sub-gate line which is any one of the gate lines;
a first capacitor connected between the first node and the third node;
a second capacitor connected between an initialization voltage node to which an initialization voltage is inputted and the third node; and
a third capacitor connected between the third node and the second node.
